(19) United States
(12) Patent Application Publication
(10) Pub. No.: US 2017/0062841 A1
(43) Pub. Date: Mar. 2, 2017

(54) BATTERY INCLUDING AN ON-CELL INDICATOR

(71) Applicant: DURACELL U.S. OPERATIONS, INC., Wilmington, DE (US)

(72) Inventors: Joern Riemer, Danbury, CT (US); Robert John Pavlinsky, Oxford, CT (US); Mathias Amann, Darmstadt (DE)

(21) Appl. No.: 14/842,266

(22) Filed: Sep. 1, 2015

(51) Int. Cl. H01M 6/50; H01M 10/48

(52) U.S. Cl. CPC H01M 6/505; H01M 10/488

(57) ABSTRACT

The invention is directed toward a battery including an on-cell indicator. The battery including an on-cell indicator includes at least one electrochemical cell; at least one on-cell indicator; and a printed circuit board. The at least one electrochemical cell includes a first terminal and a second terminal. The at least one on-cell indicator includes at least one on-cell indicator terminal. The printed circuit board includes at least one on-cell indicator contact and at least one electrochemical cell contact. The at least one electrochemical cell contact is in electrical connection with the first terminal of the at least one electrochemical cell. At least one conductive trace includes an on-cell indicator interconnect and a printed circuit board interconnect. The on-cell indicator interconnect is in electrical connection with the at least one on-cell indicator terminal. The printed circuit board interconnect is in electrical connection with the at least one on-cell indicator terminal.

### FIELD OF THE INVENTION

The invention relates to a battery including an on-cell indicator.

### BACKGROUND OF THE INVENTION

Electrochemical cells, or batteries, are commonly used as electrical energy sources. A battery contains a negative electrode and a positive electrode. The negative electrode contains an active material that can be oxidized. The positive electrode contains an active material that can be reduced. The negative active material is capable of reducing the positive active material. A separator is disposed between the negative electrode and the positive electrode. An electrolyte is also included within the battery. The aforementioned components are generally disposed in a housing, such as a metal can with an open end, that is crimped over an end cap and seal to close the battery. The battery may be primary, i.e., meant to be discharged to exhaustion one time and then discarded. The battery may, alternatively, be secondary, i.e., meant to be discharged and recharged multiple times.

Battery testers may be used to determine characteristics of the battery, such as the remaining battery capacity. An exemplary type of a common battery tester is known as a thermochromic tester. In a thermochromic tester, a circuit may be completed when a consumer manually depresses a one or two button switch. Once the switch is depressed, the consumer has connected the battery to the thermochromic tester. The thermochromic tester may include a silver resistor, e.g., a flat silver layer that has a variable width so that the electrical resistance also varies along its length. As current travels through the silver resistor, the dissipated power generates heat that changes the color of a thermochromic ink display that is placed over the silver resistor. The thermochromic ink display may be arranged as a gauge to indicate the relative capacity of the battery.

It may, however, be difficult to manufacture a battery that includes an on-cell indicator at high-speed. In addition, in may be difficult to accurately connect the battery tester to the battery. Accordingly, there exists a need for a battery including an on-cell indicator that is capable of being manufactured at high-speed. In addition, a need exists to provide an on-cell indicator that easily connects to the battery.

### SUMMARY OF THE INVENTION

In one embodiment, the invention is directed toward a battery including an on-cell indicator. The battery including an on-cell indicator includes at least one electrochemical cell; at least one on-cell indicator; and a printed circuit board. The at least one electrochemical cell includes a first terminal and a second terminal. The at least one on-cell indicator includes at least one on-cell indicator terminal. The printed circuit board includes at least one on-cell indicator contact and at least one electrochemical cell contact. The at least one electrochemical cell contact is in electrical connection with the first terminal of the at least one electrochemical cell. At least one conductive trace includes an on-cell indicator interconnect and a printed circuit board interconnect. The on-cell indicator interconnect is in electrical connection with the at least one on-cell indicator terminal. The printed circuit board interconnect is in electrical connection with the at least one on-cell indicator terminal.

### BRIEF DESCRIPTION OF THE DRAWINGS

While the specification concludes with claims particularly pointing out and distinctly claiming the subject matter, which is regarded as forming the present invention, it is believed that the invention will be better understood from the following description taken in conjunction with the accompanying drawings.

FIG. 1 is a perspective view of a battery including an on-cell indicator according to one or more embodiments shown and described herein.

FIG. 2 is a cross-section of another battery including an on-cell indicator according to one or more embodiments shown and described herein.

FIG. 3 is a cross-section of another battery including an on-cell indicator according to one or more embodiments shown and described herein.

FIG. 4 is a cross-section of another battery including an on-cell indicator according to one or more embodiments shown and described herein.

FIG. 5 is a cross-section of another battery including an on-cell indicator according to one or more embodiments shown and described herein.

FIG. 6 is a perspective view of a printed circuit board for use within a battery including an on-cell indicator according to one or more embodiments shown and described herein.

FIG. 7 is a side view of the printed circuit board of FIG. 6.

FIG. 8 is a top view of the printed circuit board of FIGS. 6 and 7.

FIG. 9 is a bottom of the printed circuit board of FIGS. 6, 7, and 8.

FIG. 10 is a perspective view of a spacer for use within a battery including an on-cell indicator according to one or more embodiments shown and described herein.

FIG. 11 is a side view of the spacer of FIG. 10.

FIG. 12 is a top view of the spacer of FIGS. 10 and 11.

FIG. 13 is a bottom view of the spacer of FIGS. 10, 11, and 12.

FIG. 14 is a view of a label for use with a battery including an on-cell indicator according to one or more embodiments shown and described herein.

### DETAILED DESCRIPTION OF THE INVENTION

The present invention is directed toward a battery including an on-cell indicator. The battery including an on-cell indicator may include at least one electrochemical cell; at least one on-cell indicator; and at least one printed circuit board (PCB). The electrochemical cell may include a first terminal and a second terminal. The PCB may be in electrical connection with, at least, the first terminal of the electrochemical cell. The on-cell indicator may be in electrical connection with the PCB. The battery including an on-cell indicator is capable of, for example, indicating to a user the amount of capacity remaining in the battery.

The electrochemical cell is capable of converting chemical energy within the active materials of the electrochemical cell by means of an electrochemical reduction-oxidation (redox) reaction to electrical energy. David Linden, Handbook of Batteries, 1.3 (4^{th} ed. 2011). The electrochemical cell consists of an anode, a cathode, and an electrolyte. Id. One or more electrochemical cells may be referred to as a battery. Electrochemical cells, or batteries, may be primary or secondary. Primary batteries are meant to be discharged, e.g., to exhaustion, only once and then discarded. Primary batteries are described, for example, in David Linden, Handbook of Batteries (4^{th} ed. 2011). Secondary batteries are intended to be recharged. Secondary batteries may be discharged and recharged multiple times, e.g., fifty times, a hundred times, or more. Secondary batteries are described, for example, in David Linden, Handbook of Batteries (4^{th} ed. 2011). Accordingly, batteries may include various electrochemical couples and electrolyte combinations. It should be appreciated that the invention applies to primary and secondary batteries of aqueous, nonaqueous, ionic liquid, and solid state systems. Primary and secondary batteries of the aforementioned systems are thus within the scope of this application and the invention is not limited to any particular embodiment.

Batteries also come in varying sizes and dimensions. The International Electrotechnical Commission (IEC), for example, has established standard sizes and dimensions for batteries available to consumers at retail. The IEC has set standard sizes and dimensions, for example, cylindrical batteries, such as AAA batteries, AA batteries, C batteries, and D batteries. Similarly, standard sizes and dimensions have been set for non-cylindrical batteries. A 9V alkaline battery, for example, has a prismatic, or rectangular, shape having dimensions set by the IEC. Individual battery or device manufacturers may also designate the dimensions for prismatic batteries that may not be generally available at retail, such as lithium ion prismatic batteries. It should be appreciated that the present invention applies to batteries of sizes and dimensions set by the IEC, such as AA, AAA, C, D, and 9V, as well as to batteries of sizes and dimensions designated by individual battery or device manufacturers. Primary and secondary batteries of the aforementioned sizes and dimensions are thus within the scope of this application and the invention is not limited to any particular embodiment.

The battery may have a first terminal and a second terminal. The first terminal of a primary battery may be, for example, the negative terminal. The second terminal of a primary battery may be, for example, the positive terminal. The first terminal of a secondary battery may be, for example, the positive terminal. The second terminal of a secondary battery may be, for example, the negative terminal. The battery may include a housing, such as a metal can, with at least one open end. The anode, cathode, and electrolyte may be placed within the housing. The first terminal may be an end cap. The housing may be crimped over the end cap, including a seal, to close the battery. The housing may be the second terminal of the battery.

The on-cell indicator may provide a visual indication using a light emitting diode (LED) circuit, a liquid-crystal display (LCD), an electrochromic display, a thermochromic display, an electro-wetting display, an electrochemical display, a MEMS display, an electrophoretic display (electronic paper), a structural color display, and/or an electrostatic display. The on-cell indicator may provide an auditory indication using, for example, a piezo buzzer, an acoustic generator and speaker, a bell or other type of percussion device or instrument, a magnetic buzzer, or electromechanical buzzer. The on-cell indicator may provide a tactile indication or a roughness indication using, for example, a pop-up protrusion or a blister. The tactile indicator or roughness indicator may be flush to the surface of the on-cell indicator in a first state and protrude from the surface of the on-cell indicator in a second state. The pallesthesia indication may be a mechanical or electromechanical means to provide the sense of vibration such as, for example, an offset weight motor or a piezoelectric bender coupled to a haptic driver or controller. The pallesthesia indication may induce a vibration in the battery electrically coupled to the on-cell indicator such that the vibration signals to a user the state of the charge of the at least one electrochemical cell.

The on-cell indicator may include at least one on-cell indicator terminal. The on-cell indicator may include a first on-cell indicator terminal and a second on-cell indicator terminal. The at least one on-cell indicator terminal; the first on-cell indicator; and the second on-cell indicator terminal may comprise any suitable material, such as an electrically conductive material.

The on-cell indicator terminal; the first on-cell indicator terminal; and the second on-cell indicator terminal may be made from copper, aluminum, silver, gold, or other conductive metals. Other suitable materials include conductive foams, conductive polymers, conductive glues, and conductive carbon, such as graphite. The on-cell indicator terminal; the first on-cell indicator terminal; and the second on-cell indicator terminal may be printed, painted, or spray coated.

The on-cell indicator terminal; the first on-cell indicator terminal; and the second on-cell indicator terminal may be made from foil. The on-cell indicator terminal; the first on-cell indicator terminal; and the second on-cell indicator terminal may be a pre-formed wire that is either insulated or bare. If the pre-formed wire is bare, it may be covered by a non-conductive sheet, a non-conductive tape, a non-conductive flexible substrate, or a non-conductive shrink wrap.

The printed circuit board includes at least one layer having an electrical circuit that is in electrical connection with the battery. A wiring pattern, or circuit, may be on or within the printed circuit board. The circuit may include a plurality of safety devices, power terminals, external connection terminals, and the like that provide additional functionality. Examples of additional functionality include a thermal heat sink(s). Examples of safety devices may include a protective module, a positive-temperature-coefficient (PTC) thermistor, and the like. The protective module may include, for example, a switching device, a control-circuit unit, a resistor, an inductor, a capacitor and the like. The PCB may comprise one or more layers, each having its own wiring pattern. The wiring pattern may comprise conductive traces or conductive foil traces. A multi-layer PCB may comprise vias between layers to provide electrical connection between the wiring patterns on each respective layer. The conductive traces may be applied to the printed circuit board by any suitable means known in the art, for example, using plating, physical vapor deposition, etching, and the like.

The printed circuit board may include a top surface, a bottom surface, and a side surface. The top surface, the bottom surface, and the side surface of the printed circuit board may include at least one on-cell indicator terminal contact. The top surface, the bottom surface, and the side surface of the printed circuit board may include a first on-cell indicator terminal contact and a second on-cell indicator terminal contact. The at least one on-cell indicator terminal contact; the first on-cell indicator terminal contact; and the second on-cell indicator terminal contact may be made from copper, aluminum, silver, gold, or other conductive metals. Other suitable materials include conductive foams, conductive polymers, conductive glues, and conductive carbon, such as graphite.

The at least one on-cell indicator terminal contact; the first on-cell indicator terminal contact; and the second on-cell indicator terminal contact may, for example, include two distinct contacts. One distinct contact may be on the bottom surface of the printed circuit board. The other distinct contact may be on the top surface of the printed circuit board. The distinct contacts of the at least one on-cell indicator terminal contact; the first on-cell indicator terminal contact; and the second on-cell indicator terminal contact may be in electrical connection with one another through the wiring of the printed circuit board.

The at least one on-cell indicator terminal contact; the first on-cell indicator terminal contact; and the second on-cell indicator terminal contact may, for example, include three distinct contacts. One distinct contact may be on the bottom surface of the printed circuit board. Another distinct contact may be on the top surface of the printed circuit board. The other distinct contact may be on the side of the printed circuit board. Any one of the distinct contacts on the top, bottom, or side surfaces of the printed circuit board may be in electrical connection with one or more of the distinct contacts on the top, the bottom, or side surfaces of the printed circuit board through the wiring on or within the printed circuit board.

The printed circuit board may include a top surface, a bottom surface, and a side surface. The top surface, the bottom surface, and the side surface of the printed circuit board may include at least one electrochemical cell contact. The top surface, the bottom surface, and the side surface of the printed circuit board may include a first electrochemical cell contact and a second electrochemical cell contact. The at least one electrochemical cell contact; the first electrochemical cell contact; and the second electrochemical cell contact may be copper, aluminum, silver, gold, or other conductive metals. Other suitable materials include conductive foams, conductive polymers, conductive glues, and conductive carbon, such as graphite.

The at least one electrochemical cell contact; the first electrochemical cell contact; and the second electrochemical cell contact may, for example, include two distinct contacts. One distinct contact may be on the bottom surface of the printed circuit board. The other distinct contact may be on the top surface of the printed circuit board. Any one of the distinct contacts on the top, bottom, or side surfaces of the printed circuit board may be in electrical connection with one or more of the distinct contacts on the top, the bottom, or side surfaces of the printed circuit board through the wiring on or within the printed circuit board.

The at least one electrochemical cell contact; the first electrochemical cell contact; and the second electrochemical cell contact may, for example, include three distinct contacts. One distinct contact may be on the bottom surface of the printed circuit board. Another distinct contact may be on the top surface of the printed circuit board. The other distinct contact may be on the side of the printed circuit board. Any one of the distinct contacts on the top, bottom, or side surfaces of the printed circuit board may be in electrical connection with one or more of the distinct contacts on the top, the bottom, or side surfaces of the printed circuit board through the wiring on or within the printed circuit board.

The at least one electrochemical cell contact may be in electrical connection with the first terminal of the battery. The first electrochemical cell contact may be in electrical connection with the first terminal of the battery. The second electrochemical cell contact may be in electrical connection with the second terminal of the battery. The at least one electrochemical cell contact; the first electrochemical cell contact; and the second electrochemical cell contact may be welded, glued, soldered, compressed, bonded, and the like to the respective terminal of the battery.

At least one tab interconnect may be included between the at least one electrochemical cell contact and the first electrochemical cell contact of the printed circuit board and the first terminal of the battery. The tab interconnect may be made from copper, aluminum, silver, gold, nickel, nickel-plated steel, or other conductive metals. Other suitable materials include conductive foams, conductive polymers, conductive glues, and conductive carbon, such as graphite. The tab interconnect may be welded, glued, soldered, compressed, bonded, and the like to the at least one electrochemical cell contact; the first electrochemical cell contact; and the first terminal of the battery.

At least one conductive trace may electrically connect the on-cell indicator terminal to the on-cell indicator terminal contact of the printed circuit board. A first conductive trace may electrically connect the first on-cell indicator terminal to the first on-cell indicator terminal contact of the printed circuit board. A second conductive trace may electrically connect the second on-cell indicator terminal to the second on-cell indicator terminal contact of the printed circuit board. The at least one conductive trace; the first conductive trace; and the second conductive trace may be made from copper, aluminum, silver, gold, or other conductive metals. Other suitable materials include conductive foams, conductive fluids, conductive polymers, conductive glues, and conductive carbon, such as graphite.

The conductive trace may include an on-cell indicator interconnect at one end of the conductive trace. The conductive trace may include a printed circuit board interconnect at another end of the conductive trace. The on-cell indicator interconnect and the printed circuit board interconnect may be made from copper, aluminum, silver, gold, or other conductive metals. Other suitable materials include conductive foams, conductive fluids, conductive polymers, conductive glues, and conductive carbon, such as graphite.

The first conductive trace may include a first on-cell indicator interconnect at one end of the first conductive trace. The first conductive trace may include a first printed circuit board interconnect at another end of the first conductive trace. The second conductive trace may include a second on-cell indicator interconnect at one end of the second conductive trace. The second conductive trace may include a second printed circuit board interconnect at another end of the second conductive trace. The first on-cell indicator interconnect; the second on-cell indicator interconnect; the first printed circuit board interconnect; and the second printed circuit board interconnect may be made from copper, aluminum, silver, gold, or other conductive metals. Other suitable materials include conductive foams, conductive fluids, conductive polymers, conductive glues, and conductive carbon, such as graphite.

The battery including an on-cell indicator may also include a spacer. The spacer includes a top surface. The top surface of the spacer may include at least one spacer printed circuit board contact. The at least one spacer printed circuit board contact may be made from copper, aluminum, silver, gold, or other conductive metals. Other suitable materials include conductive foams, conductive fluids, conductive polymers, conductive glues, and conductive carbon, such as graphite.

The spacer includes a bottom surface. The bottom surface of the spacer may include at least one spacer electrochemical cell contact. The at least one spacer electrochemical cell contact may be made from copper, aluminum, silver, gold, or other conductive metals. Other suitable materials include conductive foams, conductive fluids, conductive polymers, conductive glues, and conductive carbon, such as graphite.

The top surface and the bottom surface of the spacer may be electrically connected. The spacer may be, for example, a conductive material, such as a solid ring, a conductive tab, a conductive foam, or a conductive tape. The at least one spacer printed circuit board contact and the at least one spacer electrochemical cell contact may be in electrical connection with one another. The first spacer printed circuit board contact and the first spacer electrochemical cell contact may be in electrical connection with one another. The second spacer printed circuit board contact and the second spacer electrochemical cell contact may be in electrical connection with one another.

The battery including an on-cell indicator may also include a label. The label may be a laminated multi-layer film with a transparent or translucent layer bearing the label graphics and text. The label may be made from polyvinyl chloride (PVC), polyethylene terephthalate (PET), and other similar polymer materials. The label includes an inner surface and an outer surface. The at least one conductive trace; the first conductive trace; and the second conductive trace may be included on or within the label. The at least one on-cell indicator interconnect; the first on-cell indicator interconnect; and the second on-cell indicator interconnect may be included on or within the label.

The battery including an on-cell indicator of the present invention reduces complications that are associated with the manufacture of batteries that include on-cell indication. For example, the battery including an on-cell indicator of the present invention enables an easier, and more consistent connection, of the on-cell indicator to the battery. The battery including an on-cell indicator of the present invention also enables high manufacturing speeds.

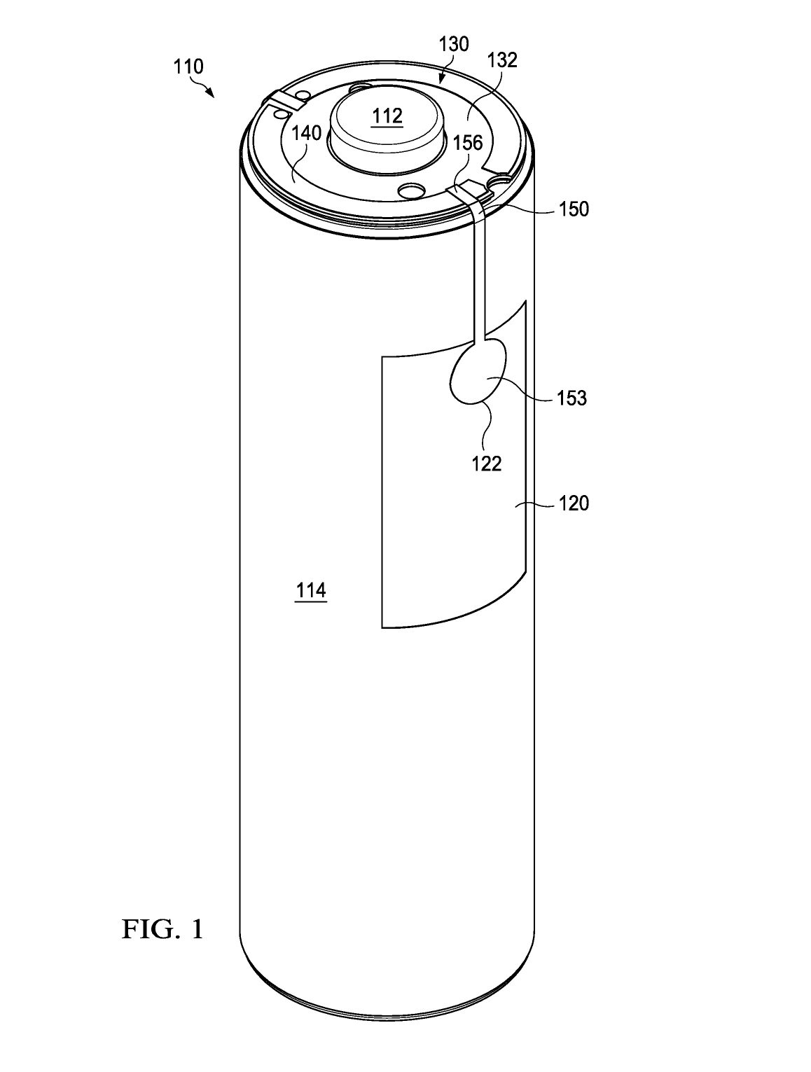

Referring to FIG. 1, a battery including an on-cell indicator is shown. The battery including an on-cell indicator includes at least one electrochemical cell (110); at least one on-cell indicator (120); a printed circuit board (130); and at least one conductive trace (150). The at least one electrochemical cell (110) includes a first terminal (112) and a second terminal (114). The at least one on-cell indicator (120) includes at least one on-cell indicator terminal (122). The printed circuit board (130) includes a top surface (132). The top surface (132) of the printed circuit board (130) includes at least one on-cell indicator terminal contact (140). The at least one conductive trace (150) includes an on-cell indicator interconnect (153) and a printed circuit board interconnect (156). The on-cell indicator interconnect (153) is in electrical connection with the at least one on-cell indicator terminal (122). The printed circuit board interconnect (156) is in electrical connection with the at least one on-cell indicator terminal contact (140).

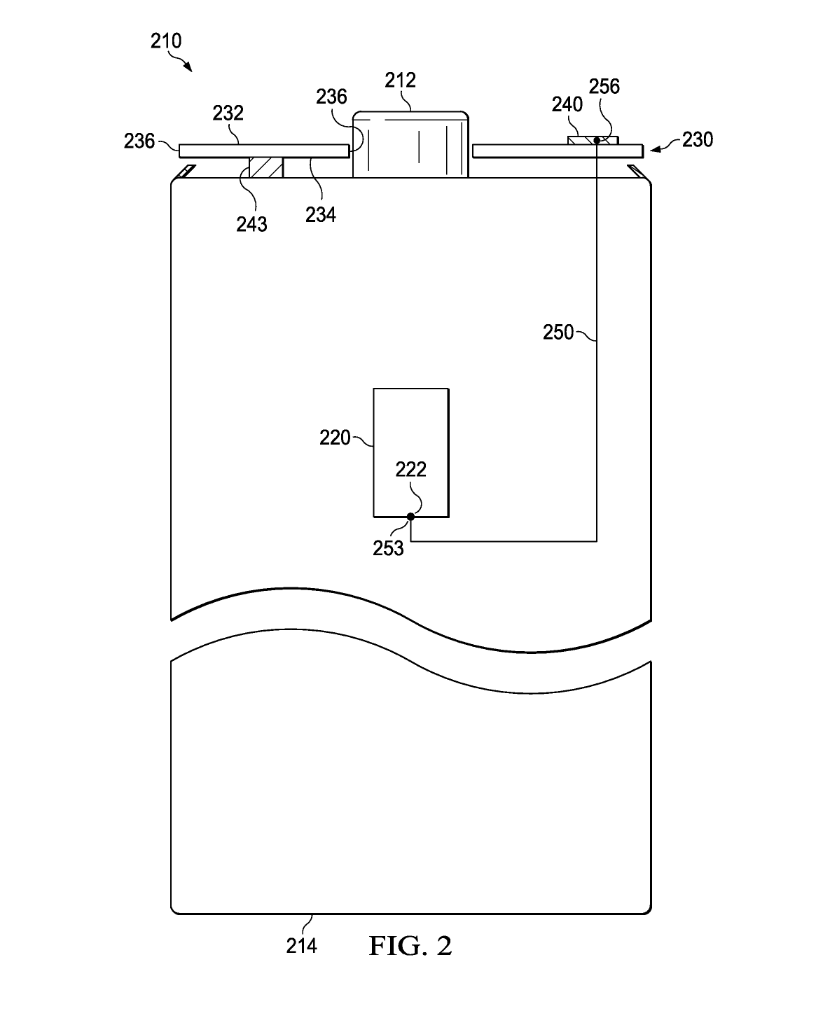

Referring to FIG. 2, a battery including an on-cell indicator is shown. The battery including an on-cell indicator includes at least one electrochemical cell (210); at least one on-cell indicator (220); a printed circuit board (230); and at least one conductive trace (250). The at least one electrochemical cell (210) includes a first terminal (212) and a second terminal (214). The at least one on-cell indicator (220) includes at least one on-cell indicator terminal (222). The printed circuit board (230) includes a top surface (232), a bottom surface (234), and a side surface (236). The top surface (232) of the printed circuit board (230) includes at least one on-cell indicator terminal contact (240). The bottom surface (234) of the printed circuit board (230) includes at least one electrochemical cell contact (243). The at least one electrochemical cell contact (243) is in electrical connection with the first terminal (212) of the at least one electrochemical cell (210). The at least one conductive trace (250) includes an on-cell indicator interconnect (253) and a printed circuit board interconnect (256). The on-cell indicator interconnect (253) is in electrical connection with the at least one on-cell indicator terminal (222). The printed circuit board interconnect (256) is in electrical connection with the at least one on-cell indicator terminal contact (240).

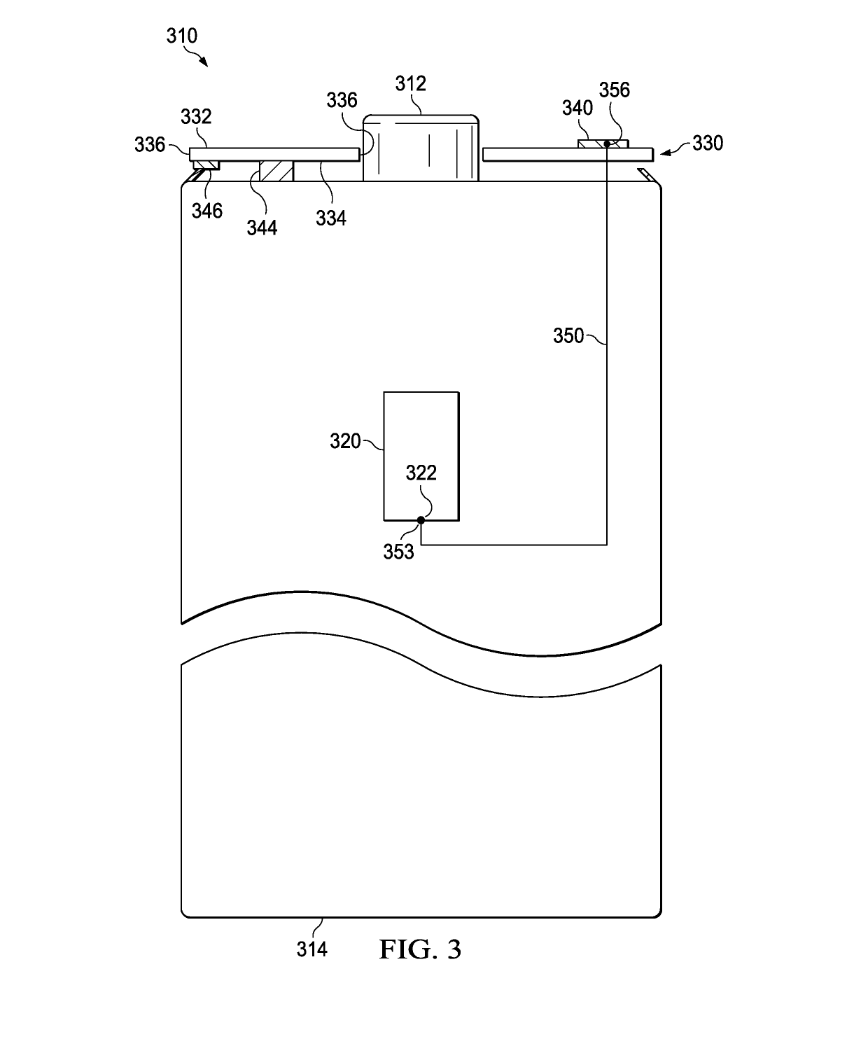

Referring to FIG. 3, a battery including an on-cell indicator is shown. The battery including an on-cell indicator includes at least one electrochemical cell (310); at least one on-cell indicator (320); a printed circuit board (330); and at least one conductive trace (350). The at least one electrochemical cell (310) includes a first terminal (312) and a second terminal (314). The at least board (330) includes a top surface (332), a bottom surface (334), and a side surface (336). The top surface (332) of the printed circuit board (330) includes at least one on-cell indicator terminal contact (340). The bottom surface (334) of the printed circuit board (330) includes a first electrochemical cell contact (344) and a second electrochemical cell contact (346). The first electrochemical cell contact (344) is in electrical connection with the first terminal (312) of the at least one electrochemical cell (310). The second electrochemical cell contact (346) is in electrical connection with the second terminal (314) of the at least one electrochemical cell (310). The at least one conductive trace (350) includes an on-cell indicator interconnect (353) and a printed circuit board interconnect (356). The on-cell indicator interconnect (353) is in electrical connection with the at least one on-cell indicator terminal (322). The printed circuit board interconnect (356) is in electrical connection with the at least one on-cell indicator terminal contact (340).

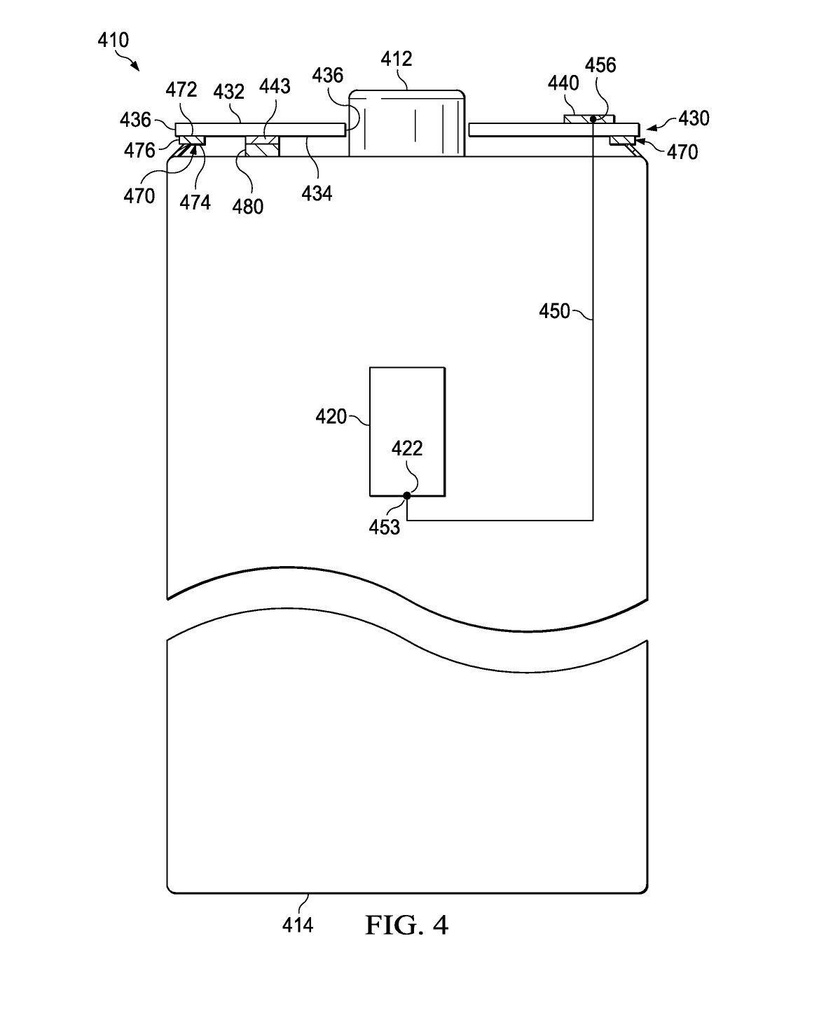

Referring to FIG. 4, a battery including an on-cell indicator is shown. The battery including an on-cell indicator includes at least one electrochemical cell (410); at least one on-cell indicator (420); a printed circuit board (430); a spacer (470); and at least one conductive trace (450). The at least one electrochemical cell (410) includes a first terminal (412) and a second terminal (414). The at least one on-cell indicator (420) includes at least one on-cell indicator terminal (422). The printed circuit board (430) includes a top surface (432), a bottom surface (434), and a side surface (436). The top surface (432) of the printed circuit board (430) includes at least one on-cell indicator terminal contact (440). The bottom surface (434) of the printed circuit board (430) includes at least one electrochemical cell contact (443). The at least one electrochemical cell contact (443) is in electrical connection with the first terminal (412) of the at least one electrochemical cell (410) through a tab interconnect (480). The spacer (470) includes a top surface (472), a bottom surface (474), and side surface (476). The spacer (470) is placed between the printed circuit board (430) and the electrochemical cell (410). The top surface (472) of the spacer (470) is in contact with the bottom surface (434) of the printed circuit board (430). The bottom surface (474) of the spacer (470) is in contact with the second terminal (414) of the electrochemical cell (410). The at least one conductive trace (450) includes an on-cell indicator interconnect (453) and a printed circuit board interconnect (456). The on-cell indicator interconnect (453) is in electrical connection with the at least one on-cell indicator terminal (422). The printed circuit board interconnect (456) is in electrical connection with the at least one on-cell indicator terminal contact (440).

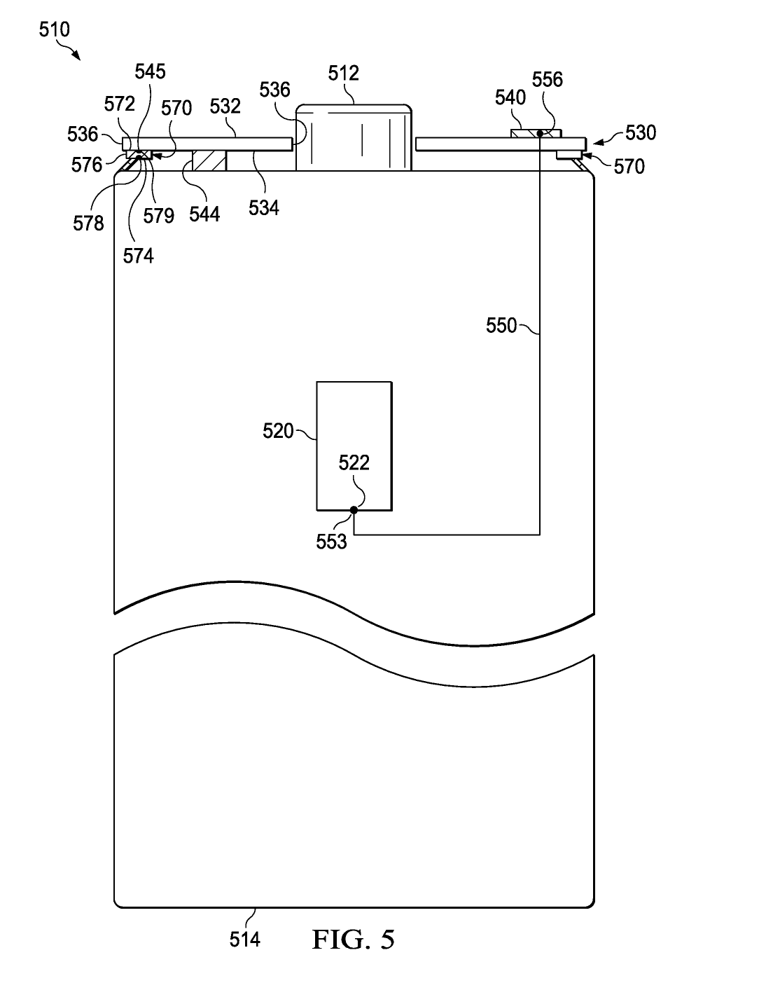

Referring to FIG. 5, a battery including an on-cell indicator is shown. The battery including an on-cell indicator includes at least one electrochemical cell (510); at least one on-cell indicator (520); a printed circuit board (530); a spacer (570); and at least one conductive trace (550). The at least one electrochemical cell (510) includes a first terminal (512) and a second terminal (514). The at least one on-cell indicator (520) includes at least one on-cell indicator terminal (522). The printed circuit board (530) includes a top surface (532), a bottom surface (534), and a side surface (536). The top surface (532) of the printed circuit board (530) includes at least one on-cell indicator terminal contact (540). The bottom surface (534) of the printed circuit board (530) includes a first electrochemical cell contact (544) and a second electrochemical cell contact (545). The first electrochemical cell contact (544) is in electrical connection with the first terminal (512) of the at least one electrochemical cell (510). The spacer (570) includes a top surface (572), a bottom surface (574), and side surface (576). The spacer (570) is placed between the printed circuit board (530) and the electrochemical cell (510). The top surface (572) of the spacer (570) includes a spacer printed circuit board contact (579). The spacer printed circuit board contact (579) is in electrical connection with the second electrochemical cell contact (545) on the bottom surface (534) of the printed circuit board (530). The bottom surface (574) of the spacer (570) includes a spacer electrochemical cell contact (578). The spacer electrochemical cell contact (578) is in electrical connection with the second terminal (514) of the at least one electrochemical cell (510). The at least one conductive trace (550) includes an on-cell indicator interconnect (553) and a printed circuit board interconnect (556). The on-cell indicator interconnect (553) is in electrical connection with the at least one on-cell indicator terminal (522). The printed circuit board interconnect (556) is in electrical connection with the at least one on-cell indicator terminal contact (540).

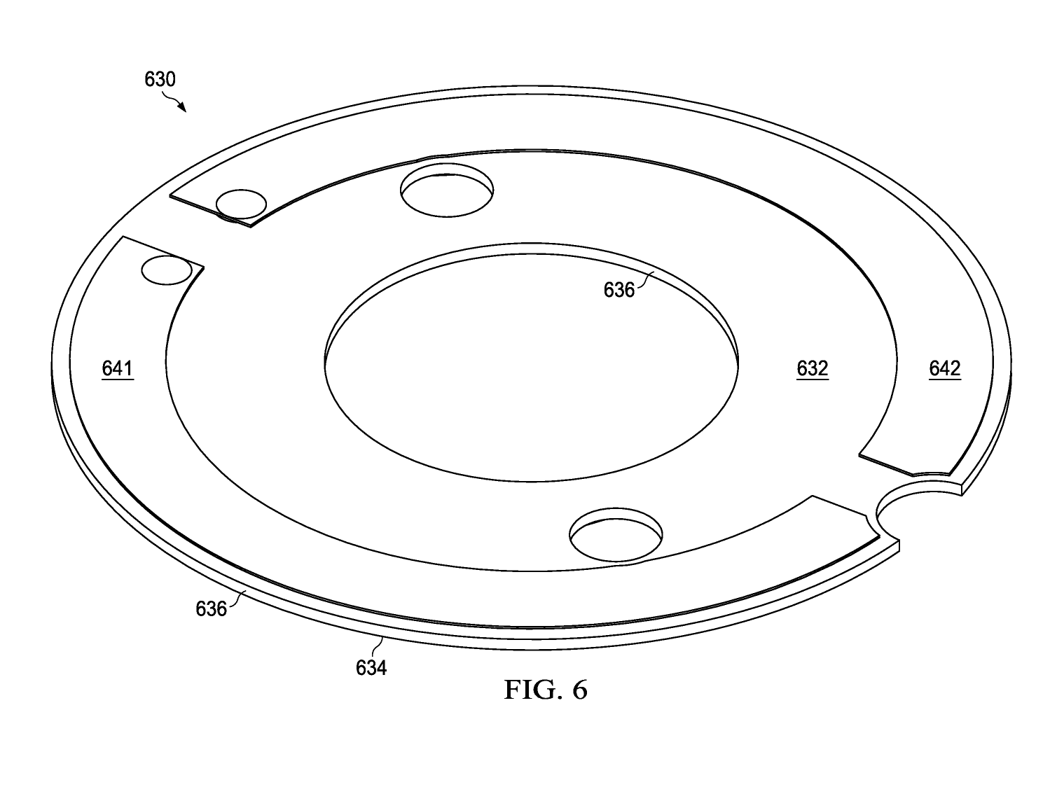

Referring to FIG. 6, a printed circuit board (630) is shown. The printed circuit board (630) includes a top surface (632), a bottom surface (634), and a side surface (636). The top surface (632) of the printed circuit board (630) includes a first on-cell indicator terminal contact (641) and a second on-cell indicator terminal contact (642).

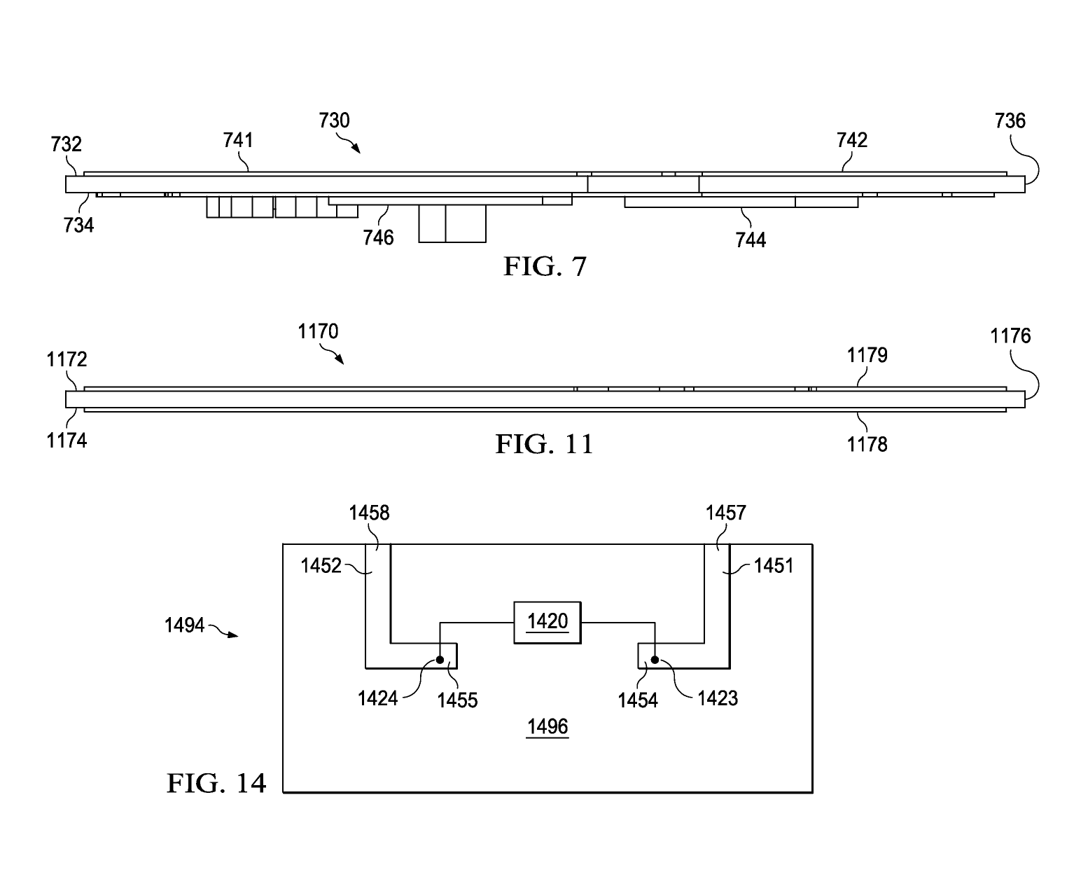

Referring to FIG. 7, another view of the printed circuit board (730) of FIG. 6 is shown. The top surface (732) of the printed circuit board (730) includes the first on-cell indicator terminal contact (741) and the second on-cell indicator terminal contact (742). The bottom surface (734) of the printed circuit board (730) includes the first electrochemical cell contact (744), and the second electrochemical cell contact (746).

Referring to FIG. 8, another view of the printed circuit board (830) of FIGS. 6 and 7 is shown. The top surface (832) of the printed circuit board (830) includes the first on-cell indicator terminal contact (841) and the second on-cell indicator terminal contact (842).

Referring to FIG. 9, another view of the printed circuit board (930) of FIGS. 6, 7, and 8 is shown. The bottom surface (934) of the printed circuit board (930) includes the first electrochemical cell contact (944), and the second electrochemical cell contact (945).

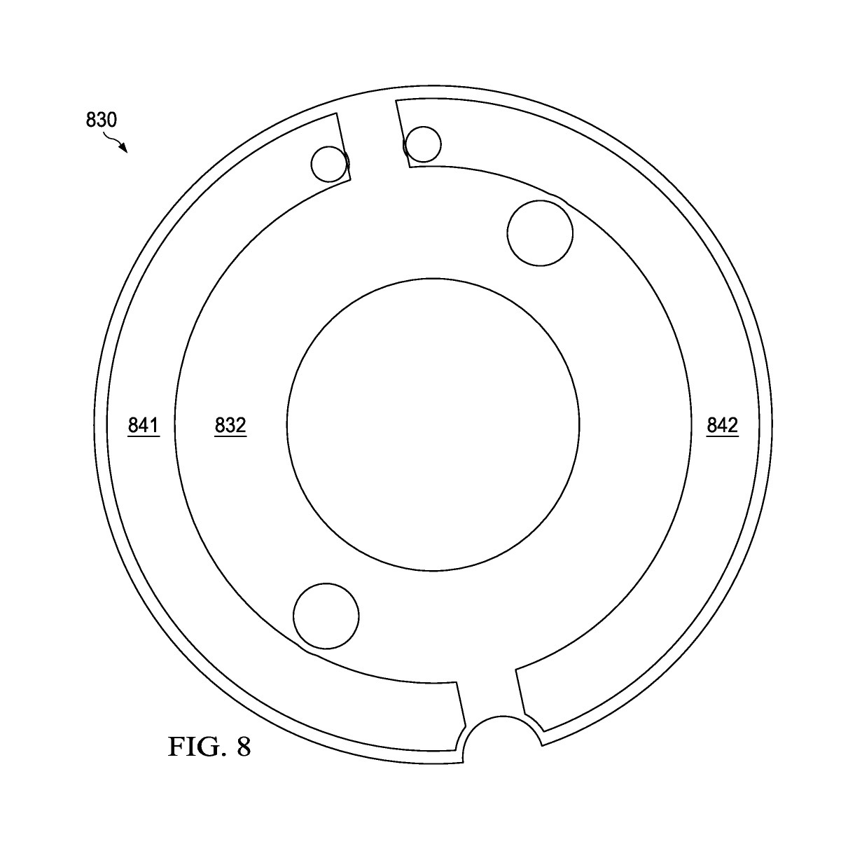

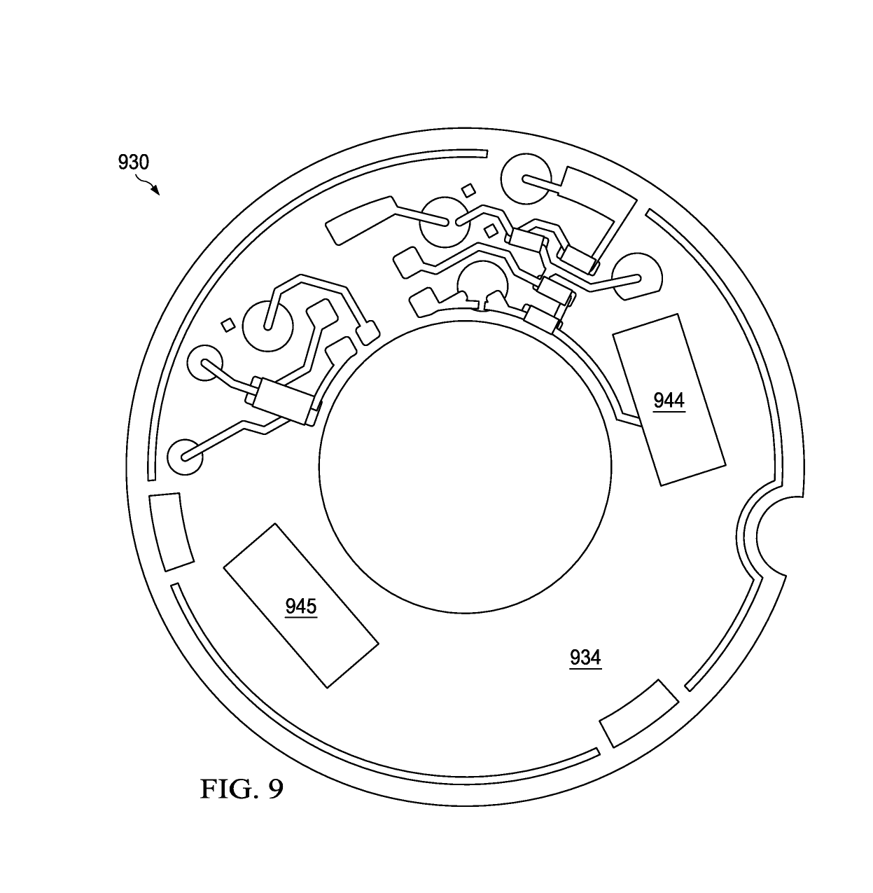

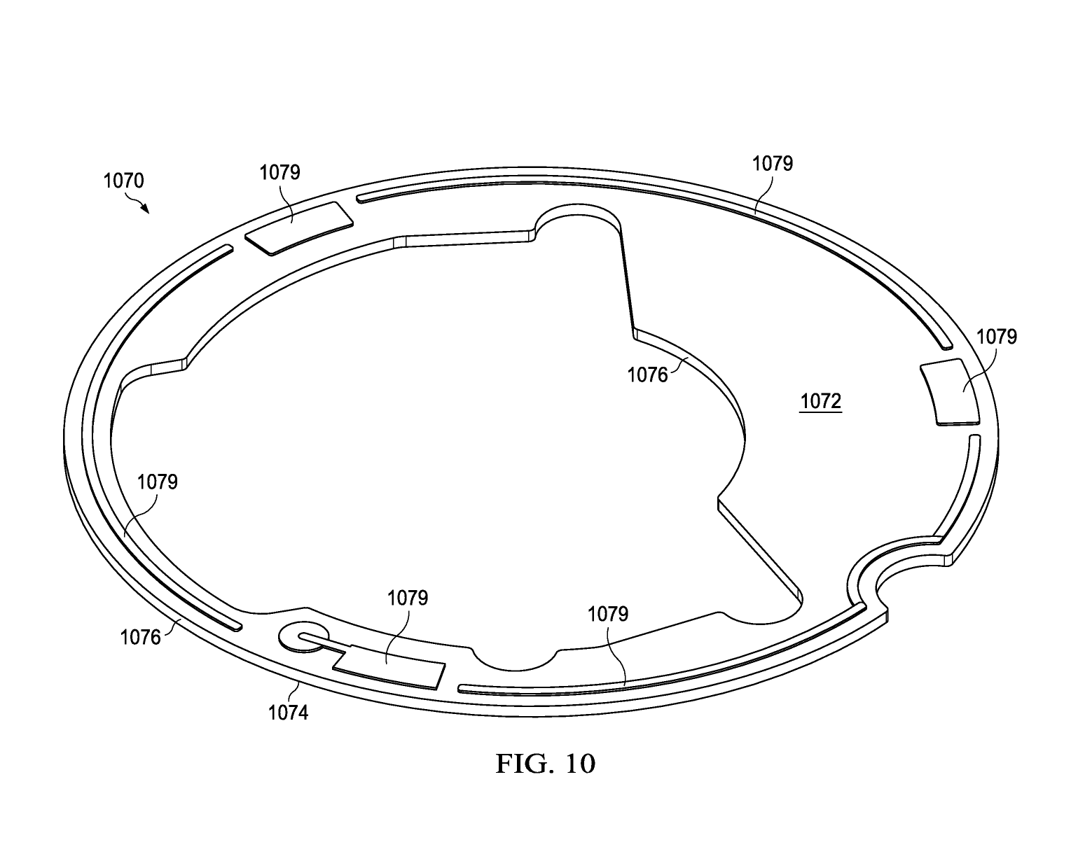

Referring to FIG. 10, a spacer (1070) is shown. The spacer includes a top surface (1072), a bottom surface (1074), and a side surface (1076). The top surface (1072) of the spacer (1070) includes the at least one spacer printed circuit board contact (1079).

Referring to FIG. 11, another view of the spacer (1170) of FIG. 10 is shown. The top surface (1172) of the spacer (1170) includes the least one spacer printed circuit board contact (1179). The bottom surface (1174) of the spacer (1170) includes the at least one spacer electrochemical cell contact (1178).

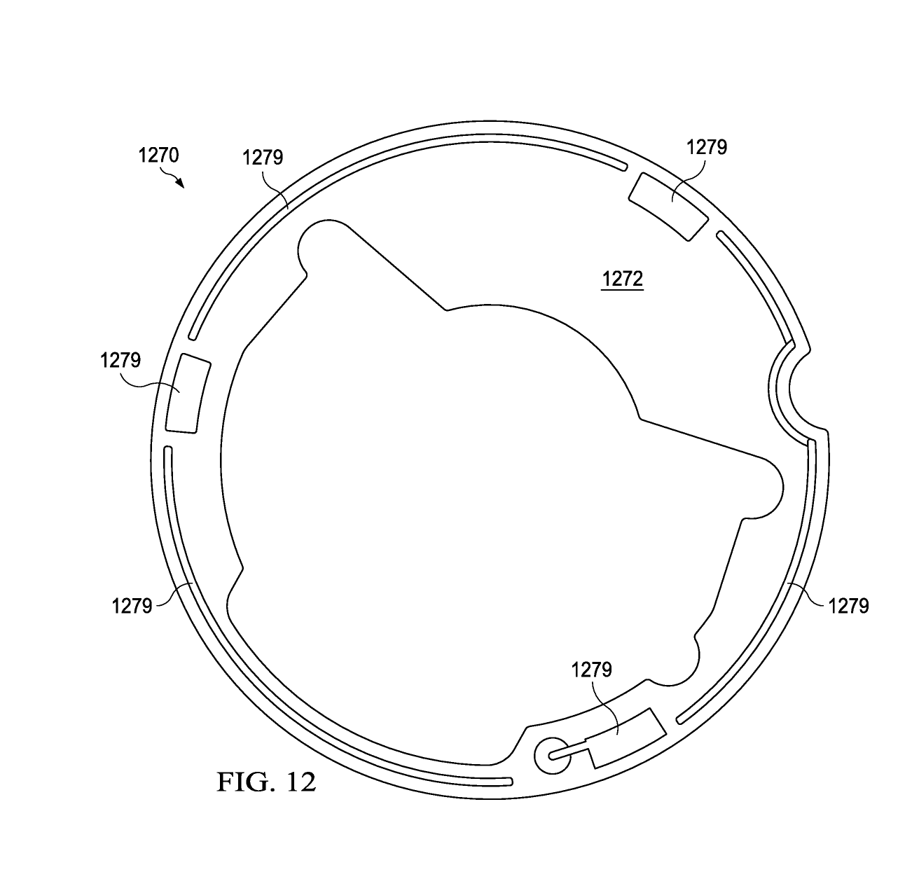

Referring to FIG. 12, another view of the spacer (1270) of FIGS. 10 and 11 is shown. The top surface (1272) of the spacer (1270) includes the at least one spacer printed circuit board contact (1279).

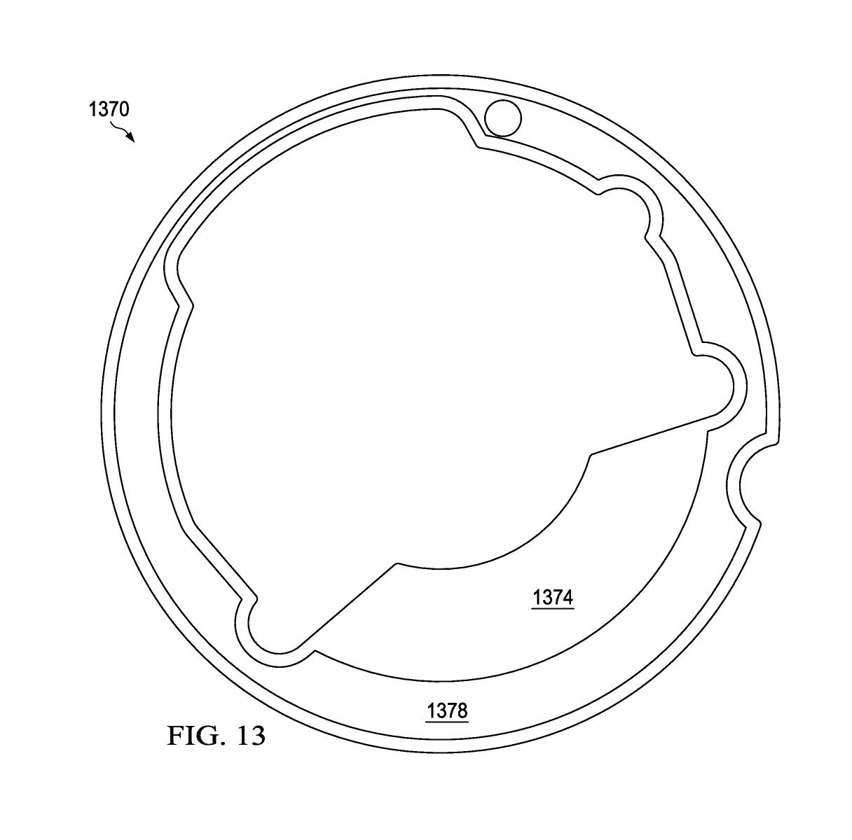

Referring to FIG. 13, another view of the spacer (1370) of FIGS. 10, 11, and 12 is shown. The bottom surface (1374) of the spacer (1370) includes the at least one spacer electrochemical cell contact (1378).

Referring to FIG. 14, a label (1494) is shown. The label (1494) includes an inner surface (1496). The inner surface (1496) of the label (1494) may be in contact with, for example, the housing of a battery. The inner surface (1496) of the label (1494) includes a first conductive trace (1451), a second conductive trace (1452), and an on-cell indicator (1420). The first conductive trace (1451) includes a first printed circuit board interconnect (1457) and a first on-cell indicator interconnect (1454). The second conductive trace (1452) includes a second printed circuit board interconnect (1458) and a second on-cell indicator interconnect (1455). The on-cell indicator (1420) includes a first on-cell indictor terminal (1423) and a second on-cell indicator terminal (1424). The first on-cell indicator interconnect (1454) is in electrical connection with the first on-cell indicator terminal (1423). The second on-cell indicator interconnect (1455) is in electrical connection with the second on-cell indicator terminal (1424).

As used herein, the term “interconnect” refers to a structure associated with one element that is configured to provide a direct electrical connection between the element and another element, for example, the on-cell indicator interconnect. As used herein, the terms “electrical contact,” “electrical connection,” “electrical coupling,” and any permutations thereof should not be limited to direct, or immediate electrical connections only. That is, such terms should not be limited to those connections where one recited element directly contacts or touches another recited element. The term “direct electrical connection” and any permutation thereof, on the other hand, should be interpreted as requiring the above-mentioned direct, or immediate, contact between the two recited elements. For example, the phrase “direct electrical connection between an element A and an element B” means that there is no intermediate element C between the elements A and B (excluding, however, soldering alloy, electro-conductive glue, and the like materials that may be used to effectuate a secure direct electrical connection), while the phrase “electrical connection (or coupling) (or contact) between an element A and an element B” should mean that there may or may not be one or more intermediate electrically-conductive elements between the elements A and B.

The dimensions and values disclosed herein are not to be understood as being strictly limited to the exact numerical values recited. Instead, unless otherwise specified, each such dimension is intended to mean both the recited value and a functionally equivalent range surrounding that value. For example, a dimension disclosed as “40 mm” is intended to mean “about 40 mm.”

Every document cited herein, including any cross referenced or related patent or application and any patent application or patent to which this application claims priority or benefit thereof, is hereby incorporated herein by reference in its entirety unless expressly excluded or otherwise limited. The citation of any document is not an admission that it is prior art with respect to any invention disclosed or claimed herein or that it alone, or in any combination with any other reference or references, teaches, suggests or discloses any such invention. Further, to the extent that any meaning or definition of a term in this document conflicts with any meaning or definition of the same term in a document incorporated by reference, the meaning or definition assigned to that term in this document shall govern.

While particular embodiments of the present invention have been illustrated and described, it would be obvious to those skilled in the art that various other changes and modifications can be made without departing from the spirit and scope of the invention. It is therefore intended to cover in the appended claims all such changes and modifications that are within the scope of this invention.

What is claimed is:

1. A battery including an on-cell indicator comprising:
at least one electrochemical cell, the at least one electrochemical cell including a first terminal and a second terminal;
at least one on-cell indicator; the at least one on-cell indicator comprising at least one on-cell indicator terminal;
a printed circuit board, the printed circuit board comprising at least one on-cell indicator terminal contact and at least one electrochemical cell contact;
the at least one electrochemical cell contact in electrical connection with the first terminal of the at least one electrochemical cell;
at least one conductive trace, the at least one conductive trace comprising an on-cell indicator interconnect and a printed circuit board interconnect;
the on-cell indicator interconnect in electrical connection with the at least one on-cell indicator terminal; and
the printed circuit board interconnect in electrical connection with the at least one on-cell indicator terminal contact.

2. The battery including an on-cell indicator of claim 1, the printed circuit board assembly comprising at least one spacer, the at least one spacer in electrical connection with the printed circuit board and the electrochemical cell.

3. The battery including an on-cell indicator of claim 1 comprising a first electrochemical cell contact and a second electrochemical cell contact; the first electrochemical cell contact and the second electrochemical cell contact on a bottom surface of the printed circuit board; the first electrochemical cell contact in electrical connection with the first terminal of the electrochemical cell; and the second electrochemical cell contact in electrical connection with the second terminal of the electrochemical cell.

4. The battery including an on-cell indicator of claim 1 comprising a first electrochemical cell contact and a second electrochemical cell contact; the first electrochemical cell contact on a bottom surface of the printed circuit board; the second electrochemical cell contact on the top surface of printed circuit board; the first electrochemical cell contact in electrical connection with the first terminal of the electrochemical cell; and the second electrochemical cell contact in electrical connection with the second terminal of the electrochemical cell.

5. The battery including an on-cell indicator of claim 1 comprising a first electrochemical cell contact and a second electrochemical cell contact; the first electrochemical cell contact on a bottom surface and a top surface of the printed circuit board; the second electrochemical cell contact on the bottom surface and the top surface of the printed circuit board; the first electrochemical cell contact in electrical connection with the first terminal of the electrochemical cell; and the second electrochemical cell contact in electrical connection with the second terminal of the electrochemical cell.

6. The battery including an on-cell indicator of claim 1 comprising a first electrochemical cell contact and a second electrochemical cell contact; the first electrochemical cell contact on a bottom surface and a top surface of the printed circuit board; the second electrochemical cell contact on the bottom surface of the printed circuit board; the first electrochemical cell contact in electrical connection with the first terminal of the electrochemical cell; and the second electrochemical cell contact in electrical connection with the second terminal of the electrochemical cell.

7. The battery including an on-cell indicator of claim 1 comprising a first electrochemical cell contact and a second electrochemical cell contact; the first electrochemical cell contact on a bottom surface and a top surface of the printed circuit board; the second electrochemical cell contact on the top surface of the printed circuit board; the first electrochemical cell contact in electrical connection with the first terminal of the electrochemical cell; and the second electrochemical cell contact in electrical connection with the second terminal of the electrochemical cell.

8. The battery including an on-cell indicator of claim 1, wherein the at least one on-cell indicator terminal contact is positioned on a bottom surface of the printed circuit board or a top surface of the printed circuit.

9. The battery including an on-cell indicator of claim 1, wherein at least one tab interconnect in electrical connection with the at least one electrochemical cell contact of the printed circuit board.

10. The battery including an on-cell indicator of claim 1, the on-cell indicator comprising an electrochromic indicator; an electrochemical indicator; a thermochromic indicator, an audible indicator; a visual indicator; a tactile indicator; a roughness indicator; an electrophoretic indicator; an electrostatic indicator; a structural color indicator; a MEMs indicator; an electro-wetting indicator; a vibratory indicator; and any combination thereof.
